(19) United States
(12) Patent Application Publication
(10) Pub. No.: US 2019/0303172 A1
(43) Pub. Date: Oct. 3, 2019

(54) INFORMATION PROCESSING APPARATUS, DEVICE ASSIGNMENT METHOD, AND COMPUTER READABLE MEDIUM

(71) Applicant: Mitsubishi Electric Corporation, Tokyo (JP)

(72) Inventors: Yurika TAKAHASHI, Tokyo (JP); Akio IDEHARA, Tokyo (JP); Takehisa MIZUGUCHI, Tokyo (JP); Ryohei KUBA, Tokyo (JP)

(73) Assignee: Mitsubishi Electric Corporation, Tokyo (JP)

(21) Appl. No.: 16/335,627

(22) PCT Filed: Nov. 16, 2016
(86) PCT No.: PCT/JP2016/083940

§ 371 Date: Mar. 21, 2019

(51) Int. Cl. G06F 9/4401; G06F 13/10

(52) U.S. Cl. CPC G06F 9/4411; G06F 13/102

(57) ABSTRACT

A hypervisor (130) assigns a first device (101) that is supported by a device driver installed in a first operating system (141) to the first operating system. In addition, the hypervisor assigns a second device (102) that is not supported by the device driver installed in the first operating system to a second operating system (142).

### TECHNICAL FIELD

The present invention relates to a technique for assigning each of one or more devices to any one of a plurality of operating systems.

### BACKGROUND ART

Due to the development of virtualization technology associated with an improvement in the performance of central processing units (CPUs), it is possible to install a plurality of operating systems (OSs) on a single information processing system.

Software that controls the plurality of OSs is called a hypervisor, and the OSs controlled by the hypervisor are called guest OSs.

The virtualization technology is used in various fields including factory automation (FA).

Specifically, the virtualization technology is used in an environment in which a real-time OS for performing processing with a high real-time property and a general-purpose OS such as Windows (registered trademark) are simultaneously executed on a single hardware platform.

Patent Literature 1 discloses a technique used when a device used by a guest OS running on a hypervisor is added, deleted, or changed.

In this technique, assignment of a device to a guest OS is changed using device configuration information prepared in advance.

That is, the device configuration information needs to be prepared in advance. Specifically, information for identifying hardware, names that identify devices, and the like, need to be registered as device configuration information.

Hence, when a device configuration is changed, a user needs to check the changed device configuration and modify the device configuration information. When the device configuration information is erroneously modified, a system may go into an inoperable state. Thus, the system needs to be able to adapt to the changed device configuration without using the device configuration information.

For example, when a newly added device is assigned to a guest OS, the user needs to modify the device configuration information. If, as a result of the modification, there is an error in the device configuration information, the system may not start up normally. Hence, there is a need to make the added device usable without the user changing the device configuration information.

### CITATION LIST

### Patent Literature

Patent Literature 1: JP 2008-269177 A

### SUMMARY OF INVENTION

### Technical Problem

An object of the present invention is to enable an information processing apparatus to assign each of one or more devices to any one of a plurality of operating systems without a user preparing device configuration information.

### Solution to Problem

One or more devices are connected to an information processing apparatus according to the present invention. In the information processing apparatus, a first operating system and a second operating system run concurrently. The information processing apparatus includes:

an assigning unit to assign a device, among the one or more devices, that is supported by a device driver installed in the first operating system to the first operating system, and assign a device, among the one or more devices, that is not supported by the device driver installed in the first operating system to the second operating system.

### Advantageous Effects of Invention

According to the present invention, an information processing apparatus can assign each of one or more devices to any one of a plurality of operating systems without a user preparing device configuration information.

### BRIEF DESCRIPTION OF DRAWINGS

FIG. 1 is a diagram illustrating a hardware configuration and a software configuration of an information processing apparatus 100 of a first embodiment.

FIG. 2 is a functional configuration diagram of a processor 120 of the first embodiment.

FIG. 3 is a data configuration diagram of an auxiliary storage apparatus 113 of the first embodiment.

FIG. 4 is a flowchart of a device assignment method of the first embodiment.

FIG. 5 is a flowchart of a change to a device configuration (S100) of the first embodiment.

FIG. 6 is a flowchart of device assignment (S200) of the first embodiment.

FIG. 7 is a flowchart of the device assignment (S200) of the first embodiment.

FIG. 8 is a flowchart of a classification process (S230) of the first embodiment.

FIG. 9 is a hardware configuration diagram of the information processing apparatus 100 of the embodiment.

### DESCRIPTION OF EMBODIMENTS

In an embodiment and the drawings, the same elements and corresponding elements are denoted by the same reference signs. Description of elements denoted by the same reference signs is omitted or simplified as appropriate. Arrows in the drawings mainly indicate the flow of data or the flow of a process.

### First Embodiment

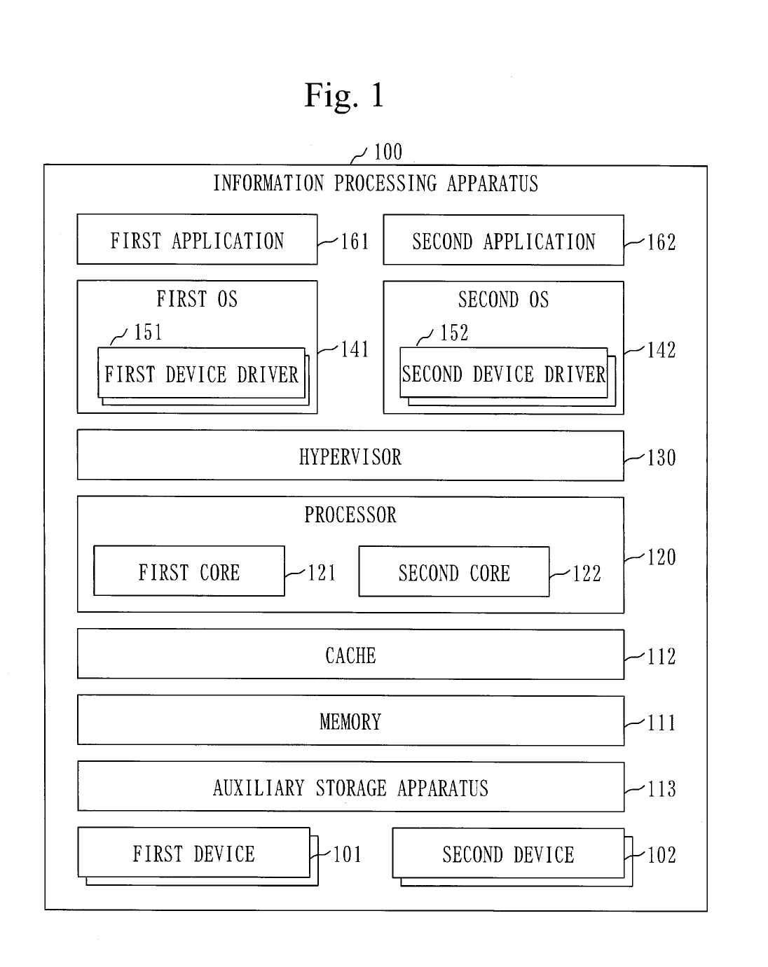

A mode in which one or more devices are assigned to any one of a plurality of operating systems will be described based on FIGS. 1 to 8.

***Description of Configuration***

Based on FIG. 1, a hardware configuration and a software configuration of an information processing apparatus 100 will be described.

The information processing apparatus 100 is a computer including hardware such as a memory 111, a cache 112, an auxiliary storage apparatus 113, and a processor 120. These pieces of hardware are connected to each other through signal lines.

The memory 111 and the cache 112 are volatile storage apparatuses. The memory 111 is also called a main storage apparatus. For example, the memory 111 is a random access memory (RAM). The cache 112 includes a shared cache.

The auxiliary storage apparatus 113 is a nonvolatile storage apparatus. For example, the auxiliary storage apparatus 113 is a read only memory (ROM), a hard disk drive (HDD), or a flash memory.

The memory 111, the cache 112, and the auxiliary storage apparatus 113 function as a storage unit that stores data.

The processor 120 is a multi-core processor including a plurality of processor cores. For example, the processor 120 is a multi-core central processing unit (CPU).

In the first embodiment, the processor 120 includes a first core 121 and a second core 122. The first core 121 and the second core 122 are processor cores.

In the information processing apparatus 100 there are installed pieces of software such as a hypervisor 130, a first operating system 141, a second operating system 142, a first application 161, and a second application 162. These pieces of software are loaded into the memory 111 and executed by the processor 120.

The hypervisor 130 is software for allowing a plurality of operating systems (OSs) to run concurrently. The operating systems controlled by the hypervisor 130 are referred to as guest OSs.

The first operating system 141 and the second operating system 142 are guest OSs controlled by the hypervisor 130.

The first operating system 141 and the second operating system 142 run concurrently.

The first operating system 141 and the second operating system 142 are executed by different processor cores. Specifically, the first operating system 141 is executed by the first core 121, and the second operating system 142 is executed by the second core 122.

The first application 161 is an application program that is executed by using a function of the first operating system 141.

The second application 162 is an application program that is executed by using a function of the second operating system 142.

For example, the first operating system 141 is a real-time OS, and the first application 161 is a real-time application. The real-time OS is an OS for executing a real-time application. The real-time application is an application program for real-time processing. The real-time processing is processing with a high real-time property.

For example, the second operating system 142 is a general-purpose OS, and the second application 162 is a general-purpose application. The general-purpose OS is an OS for executing a general-purpose application. The general-purpose application is an application program for general-purpose processing. The general-purpose processing is processing other than the real-time processing.

One or more devices that are assigned to either one of the first operating system 141 and the second operating system 142 are connected to the information processing apparatus 100.

A device assigned to the first operating system 141 is referred to as a first device 101, and a device assigned to the second operating system 142 is referred to as a second device 102.

In the first operating system 141, first device drivers 151 are installed and second device drivers 152 are not installed.

In the second operating system 142, the second device drivers 152 are installed and the first device drivers 151 are not installed.

The first device drivers 151 are device drivers that support first devices 101, and the second device drivers 152 are device drivers that support second devices 102.

The first devices 101 are devices supported by the first device drivers 151, and the second devices 102 are devices supported by the second device drivers 152.

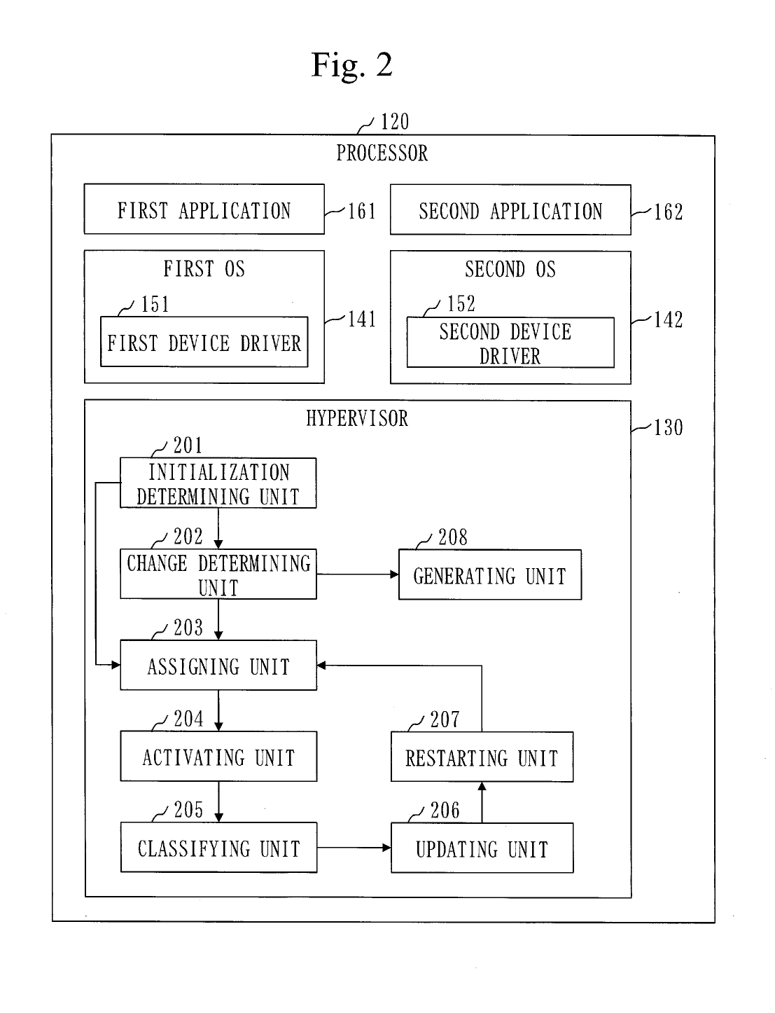

Based on FIG. 2, a functional configuration of the processor 120 included in the information processing apparatus 100 will be described.

The processor 120 includes, as functional configuration elements, an initialization determining unit 201, a change determining unit 202, an assigning unit 203, an activating unit 204, a classifying unit 205, an updating unit 206, a restarting unit 207, and a generating unit 208. These functional configuration elements are implemented by software. Specifically, these functional configuration elements are implemented as a part of the hypervisor 130.

A program for causing the information processing apparatus 100 to function as the initialization determining unit 201, the change determining unit 202, the assigning unit 203, the activating unit 204, the classifying unit 205, the updating unit 206, the restarting unit 207, and the generating unit 208 is referred to as a device assignment program.

The device assignment program is stored in the auxiliary storage apparatus 113, loaded into the memory 111, and executed by the processor 120.

The device assignment program can be stored in a nonvolatile storage medium such as a magnetic disk, an optical disc, or a flash memory in a computer-readable manner. The nonvolatile storage medium is a non-transitory tangible medium.

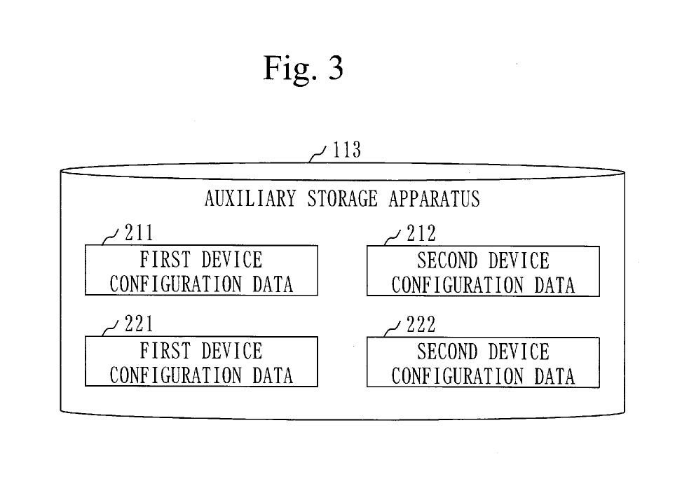

Based on FIG. 3, data stored in the auxiliary storage apparatus 113 will be described.

First device configuration data 211, second device configuration data 212, first device configuration data 221, and second device configuration data 222 are stored in the auxiliary storage apparatus 113.

The first device configuration data 211 is first device configuration data for initialization.

The second device configuration data 212 is second device configuration data for initialization.

The first device configuration data 221 is current first device configuration data.

The second device configuration data 222 is current second device configuration data.

The first device configuration data is data in which devices assigned to the first operating system 141 are registered.

The second device configuration data is data in which devices assigned to the second operating system 142 are registered.

The first device configuration data 211, the second device configuration data 212, the first device configuration data 221, and the second device configuration data 222 are loaded into the memory 111 and used as necessary at start-up of the information processing apparatus 100, and are saved in the auxiliary storage apparatus 113 as necessary upon stop of the information processing apparatus 100.

***Description of Operation***

Operation performed by the information processing apparatus 100 and a user of the information processing apparatus 100 corresponds to a device assignment method. In addition, a procedure of the device assignment method for the information processing apparatus 100 corresponds to a procedure of the device assignment program.

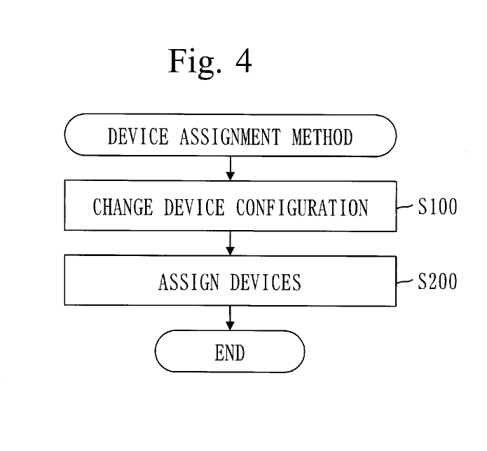

Based on FIG. 4, the device assignment method will be described.

At step S100, the user changes the device configuration of the information processing apparatus 100 as necessary.

The device configuration refers to the configuration of the first devices 101, the second devices 102, the first device drivers 151, and the second device drivers 152.

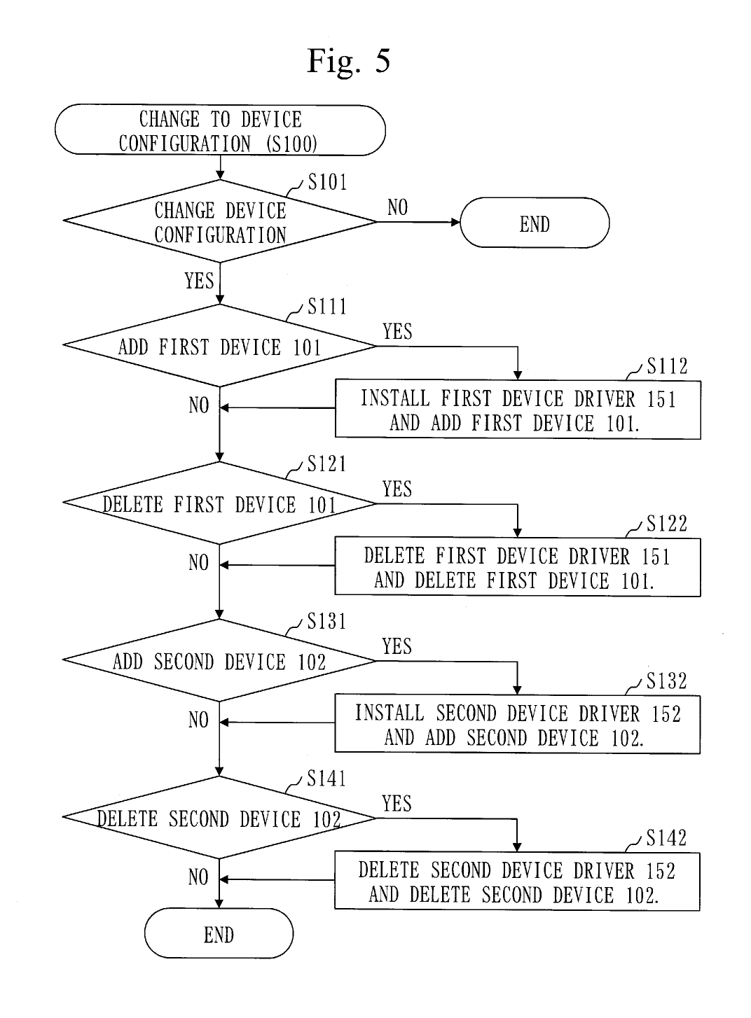

Based on FIG. 5, a change to the device configuration (S100) will be described.

At step S101, the user determines whether to change the device configuration of the information processing apparatus 100.

If the user determines to change the device configuration of the information processing apparatus 100, the user starts up the information processing apparatus 100 and processing proceeds to step S111.

If it is determined not to change the device configuration of the information processing apparatus 100, a change to the device configuration (S100) ends.

At step S111, the user determines whether to add a first device 101 to the information processing apparatus 100.

If the user determines to add a first device 101 to the information processing apparatus 100, processing proceeds to step S112.

If the user determines not to add a first device 101 to the information processing apparatus 100, processing proceeds to step S121.

At step S112, the user installs a first device driver 151 that supports the first device 101 to be added, in the first operating system 141 of the information processing apparatus 100.

Then, the user adds the first device 101 to the information processing apparatus 100. Specifically, the user connects the first device 101 to the information processing apparatus 100.

Note that when the first device 101 to be added is a device having been assigned to the second operating system 142, the user deletes a second device driver 152 that supports the device from the second operating system 142.

At step S121, the user determines whether to delete a first device 101 from the information processing apparatus 100.

If the user determines to delete a first device 101 from the information processing apparatus 100, processing proceeds to step S122.

If the user determines not to delete a first device 101 from the information processing apparatus 100, processing proceeds to step S131.

At step S122, the user deletes a first device driver 151 that supports the first device 101 to be deleted, from the first operating system 141 of the information processing apparatus 100.

Then, the user deletes the first device 101 from the information processing apparatus 100. Specifically, the user disconnects the first device 101 from the information processing apparatus 100.

At step S131, the user determines whether to add a second device 102 to the information processing apparatus 100.

If the user determines to add a second device 102 to the information processing apparatus 100, processing proceeds to step S132.

If the user determines not to add a second device 102 to the information processing apparatus 100, processing proceeds to step S141.

At step S132, the user installs a second device driver 152 that supports the second device 102 to be added, in the second operating system 142 of the information processing apparatus 100.

Then, the user adds the second device 102 to the information processing apparatus 100. Specifically, the user connects the second device 102 to the information processing apparatus 100.

Note that when the second device 102 to be added is a device having been assigned to the first operating system 141, the user deletes a first device driver 151 that supports the device from the first operating system 141.

At step S141, the user determines whether to delete a second device 102 from the information processing apparatus 100.

If the user determines to delete a second device 102 from the information processing apparatus 100, processing proceeds to step S142.

If the user determines not to delete a second device 102 from the information processing apparatus 100, the user stops the information processing apparatus 100 and a change to the device configuration (S100) ends.

At step S142, the user deletes a second device driver 152 that supports the second device 102 to be deleted, from the second operating system 142 of the information processing apparatus 100.

In addition, the user deletes the second device 102 from the information processing apparatus 100. Specifically, the user disconnects the second device 102 from the information processing apparatus 100.

Then, the user stops the information processing apparatus 100.

Referring back to FIG. 4, step S200 will be described.

At step S200, the user starts up the information processing apparatus 100.

The information processing apparatus 100 assigns first devices 101 to the first operating system 141, and assigns second devices 102 to the second operating system 142.

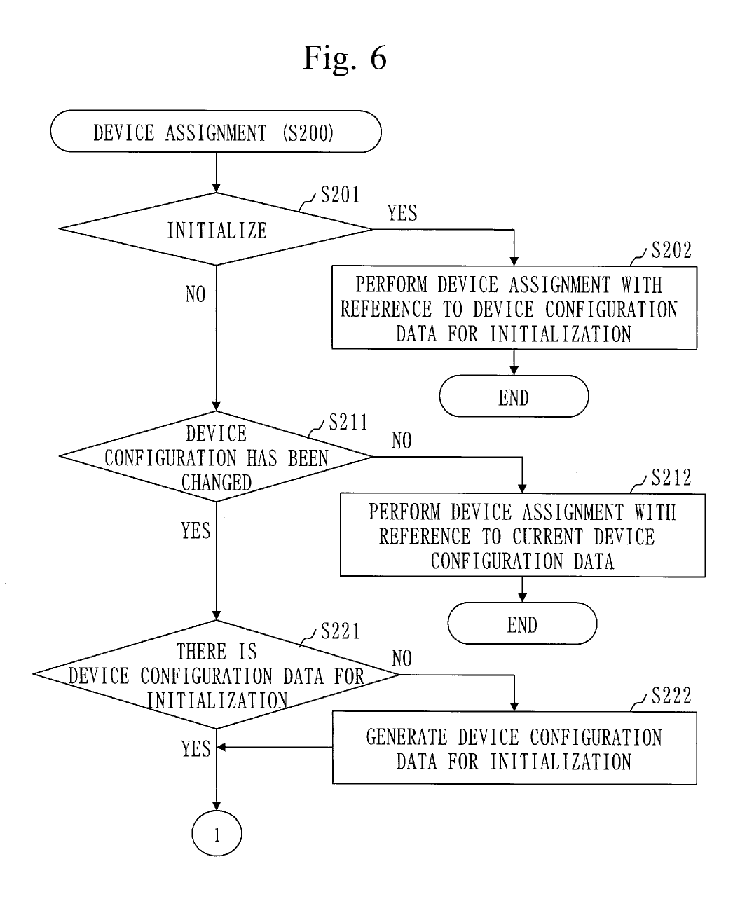

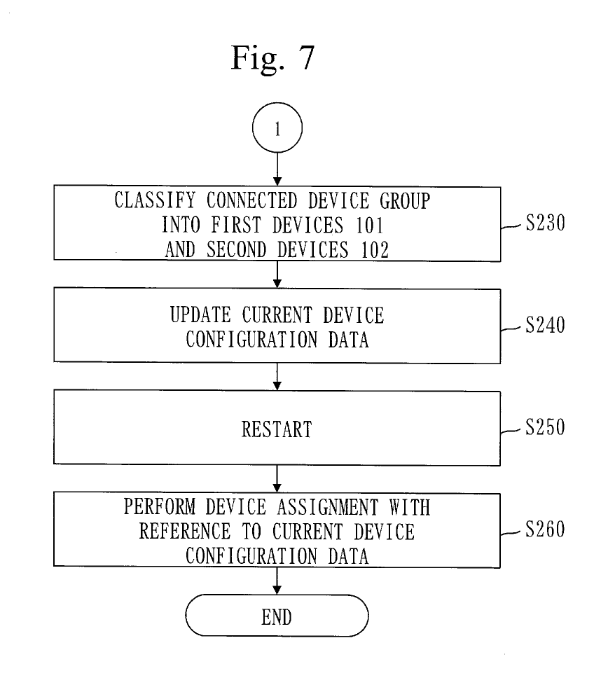

Based on FIGS. 6 and 7, device assignment (S200) will be described.

First, based on FIG. 6, step S201 to S222 will be described.

At step S201, the initialization determining unit 201 determines whether to assign devices using device configuration data for initialization.

Specifically, when the user wants to initialize the device configuration, the user inputs an initialization instruction to the information processing apparatus 100 when starting up the information processing apparatus 100. The initialization instruction is an instruction that instructs to initialize the device configuration. For example, the user starts up the information processing apparatus 100 while pressing a key that is predetermined as a key for initialization. Then, the initialization determining unit 201 determines whether an initialization instruction has been inputted. If an initialization instruction has been inputted, device assignment is performed using device configuration data for initialization.

If device assignment is performed using device configuration data for initialization, processing proceeds to step S202.

If device assignment is not performed using device configuration data for initialization, processing proceeds to step S211.

At step S202, it is assumed that the information processing apparatus 100 is in the following state:

There is device configuration data for initialization. That is, first device configuration data 211 and second device configuration data 212 are stored in the auxiliary storage apparatus 113.

First devices 101 and second devices 102 for the information processing apparatus 100 in an initial state are connected to the information processing apparatus 100.

First device drivers 151 for the information processing apparatus 100 in the initial state are installed in the first operating system 141.

Second device drivers 152 for the information processing apparatus 100 in the initial state are installed in the second operating system 142.

The assigning unit 203 performs device assignment with reference to the device configuration data for initialization.

Specifically, the assigning unit 203 operates as follows:

The assigning unit 203 assigns first devices 101 to the first operating system 141 with reference to the first device configuration data 211. That is, the assigning unit 203 assigns first devices 101 registered in the first device configuration data 211 to the first operating system 141.

The assigning unit 203 assigns second devices 102 to the second operating system 142 with reference to the second device configuration data 212. That is, the assigning unit 203 assigns second devices 102 registered in the second device configuration data 212 to the second operating system 142.

In addition, the assigning unit 203 deletes current device configuration data from the memory 111 and the auxiliary storage apparatus 113.

Then, the activating unit 204 activates the first operating system 141 and the second operating system 142.

At step S211, the change determining unit 202 determines whether the device configuration of the information processing apparatus 100 has been changed.

Specifically, the change determining unit 202 operates as follows:

When there are no first device configuration data 221 and no second device configuration data 222, the change determining unit 202 determines that the device configuration has been changed.

When there are first device configuration data 221 and second device configuration data 222, the change determining unit 202 operates as follows:

First, the change determining unit 202 detects a device group connected to the information processing apparatus 100. The device group is one or more devices.

Then, the change determining unit 202 compares the detected device group with a registered-device group. The registered-device group is a device group registered in the first device configuration data 221 and the second device configuration data 222. When the detected device group does not match the registered-device group, the change determining unit 202 determines that the device configuration has been changed.

In addition, the change determining unit 202 detects a first device driver group installed in the first operating system 141. The first device driver group is one or more first device drivers 151.

Then, the change determining unit 202 compares the detected first device driver group with a first registered-driver group. The first registered-driver group is a device driver group that supports the device group registered in the first device configuration data 221. The device driver group is one or more device drivers. When the detected first device driver group does not match the first registered-driver group, the change determining unit 202 determines that the device configuration has been changed.

In addition, the change determining unit 202 detects a second device driver group installed in the second operating system 142. The second device driver group is one or more second device drivers 152.

Then, the change determining unit 202 compares the detected second device driver group with a second registered-driver group. The second registered-driver group is a device driver group that supports the device group registered in the second device configuration data 222. When the detected second device driver group does not match the second registered-driver group, the change determining unit 202 determines that the device configuration has been changed.

If the device configuration of the information processing apparatus 100 has been changed, processing proceeds to step S221.

If the device configuration of the information processing apparatus 100 has not been changed, processing proceeds to step S212.

At step S212, the assigning unit 203 performs device assignment with reference to current device configuration data.

Specifically, the assigning unit 203 operates as follows:

The assigning unit 203 assigns first devices 101 to the first operating system 141 with reference to the first device configuration data 221. That is, the assigning unit 203 assigns first devices 101 registered in the first device configuration data 221 to the first operating system 141.

The assigning unit 203 assigns second devices 102 to the second operating system 142 with reference to the second device configuration data 222. That is, the assigning unit 203 assigns second devices 102 registered in the second device configuration data 222 to the second operating system 142.

Then, the activating unit 204 activates the first operating system 141 and the second operating system 142.

At step S221, the generating unit 208 determines whether there is device configuration data for initialization. That is, the generating unit 208 determines whether first device configuration data 211 and second device configuration data 212 are stored in the auxiliary storage apparatus 113.

If there is device configuration data for initialization, processing proceeds to step S230 (see FIG. 7).

If there is no device configuration data for initialization, processing proceeds to step S222.

At step S222, the generating unit 208 generates device configuration data for initialization. That is, the generating unit 208 generates first device configuration data 211 and second device configuration data 212. By this, device configuration data for initialization is generated when the information processing apparatus 100 starts up for the first time. It is assumed that information required to generate device configuration data for initialization can be obtained by the processor 120, or is stored in the auxiliary storage apparatus 113.

Then, the generating unit 208 stores the device configuration data for initialization in the auxiliary storage apparatus 113.

Next, based on FIG. 7, step S230 to step S260 will be described.

At step S230, the classifying unit 205 classifies a connected device group into first devices 101 and second devices 102. The connected device group is one or more devices connected to the information processing apparatus 100.

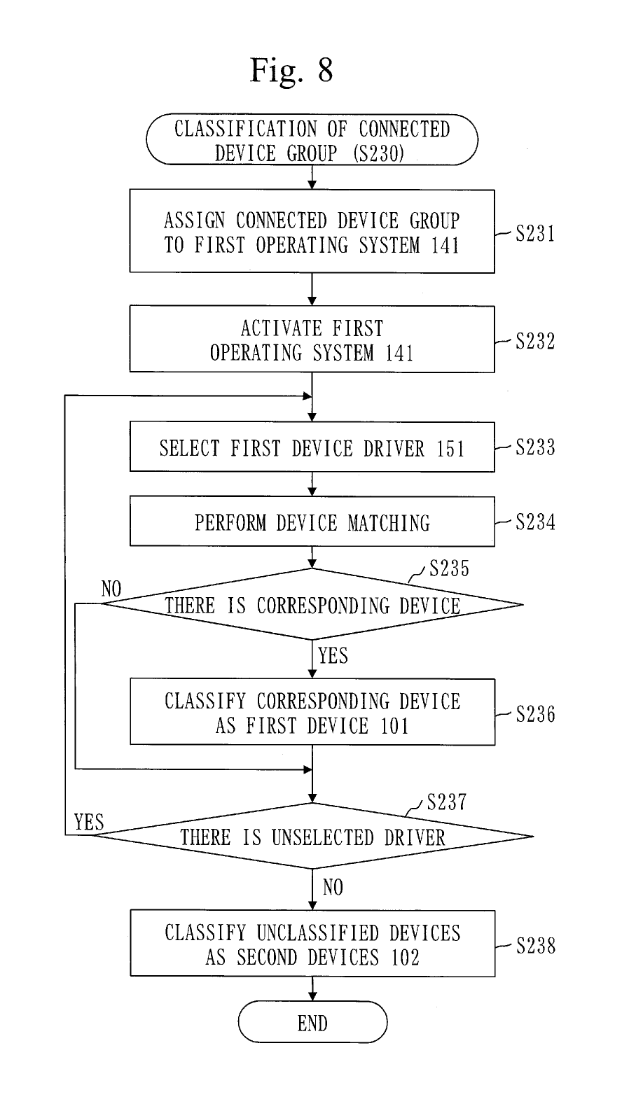

Based on FIG. 8, the classification of the connected device group (S230) will be described.

At step S231, the assigning unit 203 assigns the connected device group to the first operating system 141.

At step S232, the activating unit 204 activates the first operating system 141.

At step S233, the classifying unit 205 selects one unselected first device driver 151 from first device drivers 151 installed in the first operating system 141.

At step S234, the classifying unit 205 requests the selected first device driver 151 for device matching.

The selected first device driver 151 performs device matching. The device matching is a process of checking whether there is a corresponding device. The corresponding device is a device supported by the device driver. Specifically, the first device driver 151 performs a process called probe.

Then, the selected first device driver 151 notifies the classifying unit 205 of a result of the device matching. The result of the device matching indicates whether there is a corresponding device. When there is a corresponding device, the results of the device matching indicates the corresponding device.

At step S235, the classifying unit 205 determines whether there is a corresponding device with reference to the notified result of the device matching.

If there is a corresponding device, processing proceeds to step S236.

If there is no corresponding device, processing proceeds to step S237.

At step S236, the classifying unit 205 classifies the corresponding device as a first device 101.

At step S237, the classifying unit 205 determines whether there is an unselected first device driver 151.

If there is an unselected first device driver 151, processing proceeds to step S233.

If there is no unselected first device driver 151, processing proceeds to step S238.

At step S238, the classifying unit 205 classifies unclassified devices as second devices 102. The unclassified devices are devices in the connected device group that are not classified as the first devices 101.

Referring back to FIG. 7, description continues from step S240.

At step S240, the updating unit 206 updates current device configuration data. That is, the updating unit 206 updates the first device configuration data 221 and the second device configuration data 222.

Specifically, the updating unit 206 operates as follows:

The updating unit 206 updates the first device configuration data 221 to a state in which the first devices 101 are registered and the second devices 102 are not registered. That is, when there is a first device 101 not registered in the first device configuration data 221, the updating unit 206 registers the first device 101 in the first device configuration data 221. In addition, when there is a second device 102 registered in the first device configuration data 221, the updating unit 206 deletes the second device 102 from the first device configuration data 221.

The updating unit 206 updates the second device configuration data 222 to a state in which the second devices 102 are registered and the first devices 101 are not registered. That is, when there is a second device 102 not registered in the second device configuration data 222, the updating unit 206 registers the second device 102 in the second device configuration data 222. In addition, when there is a first device 101 registered in the second device configuration data 222, the updating unit 206 deletes the first device 101 from the second device configuration data 222.

At step S250, the restarting unit 207 restarts the information processing apparatus 100.

At step S260, the assigning unit 203 performs device assignment with reference to the current device configuration data.

Specifically, the assigning unit 203 operates as follows:

The assigning unit 203 assigns the first devices 101 to the first operating system 141 with reference to the first device configuration data 221. That is, the assigning unit 203 assigns the first devices 101 registered in the first device configuration data 221 to the first operating system 141.

The assigning unit 203 assigns the second devices 102 to the second operating system 142 with reference to the second device configuration data 222. That is, the assigning unit 203 assigns the second devices 102 registered in the second device configuration data 222 to the second operating system 142.

Then, the activating unit 204 activates the first operating system 141 and the second operating system 142.

***Description of Implementation Examples***

Implementation examples of the device assignment method (FIGS. 4 to 8) will be described below.

### First Implementation Example

A first implementation example is a mode in which a device A is added as a first device 101 to the information processing apparatus 100.

At step S112 (see FIG. 5), the user installs a device driver [A] that supports the device [A] in the first operating system 141, and adds the device [A] to the information processing apparatus 100.

At step S230 (see FIG. 7), since the device driver [A] has been installed in the first operating system 141, the classifying unit 205 classifies the device [A] as a first device 101.

At step S240 (see FIG. 7), since the device [A] has been classified as a first device 101, the updating unit 206 registers the device [A] in the first device configuration data 221.

At step S260 (see FIG. 7), since the device [A] has been registered in the first device configuration data 221, the assigning unit 203 assigns the device [A] to the first operating system 141.

### Second Implementation Example

A second implementation example is a mode in which a device [A] is added as a second device 102 to the information processing apparatus 100.

At step S132 (see FIG. 5), the user installs a device driver [A] that supports the device [A] in the second operating system 142, and adds the device [A] to the information processing apparatus 100.

At step S230 (see FIG. 7), since the device driver [A] has not been installed in the first operating system 141, the classifying unit 205 classifies the device [A] as a second device 102.

At step S240 (see FIG. 7), since the device [A] has been classified as a second device 102, the updating unit 206 registers the device [A] in the second device configuration data 222.

At step S260 (see FIG. 7), since the device [A] has been registered in the second device configuration data 222, the assigning unit 203 assigns the device [A] to the second operating system 142.

### Third Implementation Example

A third implementation example is a mode in which a device [D] which is a first device 101 is deleted from the information processing apparatus 100.

At step S121 (see FIG. 5), the user deletes a device driver [D] that supports the device [D] from the first operating system 141, and deletes the device [D] from the information processing apparatus 100.

At step S230 (see FIG. 7), since the device driver [D] has been deleted from the first operating system 141, the classifying unit 205 does not classify the device [D] as a first device 101.

At step S240 (see FIG. 7), since the device [D] has not been classified as a first device 101, the updating unit 206 deletes the device [D] from the first device configuration data 221.

At step S260 (see FIG. 7), since the device [D] has not been registered in the first device configuration data 221, the assigning unit 203 does not assign the device [D] to the first operating system 141.

### Fourth Implementation Example

A fourth implementation example is a mode in which a device [D] which is a second device 102 is deleted from the information processing apparatus 100.

At step S141 (see FIG. 5), the user deletes a device driver [D] that supports the device [D] from the second operating system 142, and deletes the device [D] from the information processing apparatus 100.

At step S230 (see FIG. 7), since the device [D] has been deleted from the information processing apparatus 100, the classifying unit 205 does not classify the device [D] as a second device 102.

At step S240 (see FIG. 7), since the device [D] has not been classified as a second device 102, the updating unit 206 deletes the device [D] from the second device configuration data 222.

At step S260 (see FIG. 7), since the device [D] has not been registered in the second device configuration data 222, the assigning unit 203 does not assign the device [D] to the second operating system 142.

### Advantageous Effects of the First Embodiment

The information processing apparatus 100 can assign each of one or more devices to either one of the first operating system 141 and the second operating system 142.

To change device assignment, the user only needs to add or delete a device driver, and does not need to edit the first device configuration data 221 and the second device configuration data 222.

That is, without the user preparing device configuration information, the information processing apparatus 100 can assign each of one or more devices to any one of a plurality of operating systems.

### Other Configurations

The number of guest OSs may be three or more.

The first device configuration data 211 and the second device configuration data 212 may be included in a single file. The first device configuration data 221 and the second device configuration data 222 may be included in a single file.

The hypervisor 130 may be executed by either one of the first core 121 and the second core 122. In addition, the processor 120 may include a processor core dedicated to execute the hypervisor 130.

The hypervisor 130 may be replaced by a host OS.

At step S231, all devices are assigned to the first operating system 141. Hence, when all devices are classified as first devices 101 at step S234, the second operating system 142 may be activated at step S260 without performing a restart at step S250. By this, the time required for the first operating system 141 and the second operating system 142 to be ready to be used can be reduced.

In addition to device configuration data for initialization and current device configuration data, past device configuration data may be saved.

The user inputs an instruction that specifies any of the device configuration data to the information processing apparatus 100 at start-up of the information processing apparatus 100. Specifically, the user presses a key corresponding to any of the device configuration data.

Then, the assigning unit 203 performs device assignment with reference to the specified device configuration data.

In this case, at step S240, the updating unit 206 inquires whether to save current device configuration data as past device configuration data before updating the current device configuration data. Specifically, the updating unit 206 displays an inquiry on a display. The user responds to the inquiry by operating a keyboard or a mouse. Then, when there is a response indicating that the current device configuration data is saved as the past device configuration data, the updating unit 206 saves the current device configuration data as the past device configuration data before updating the current device configuration data.

### Supplementary Remarks on the Embodiment

In the embodiment, the functions of the information processing apparatus 100 may be implemented by hardware.

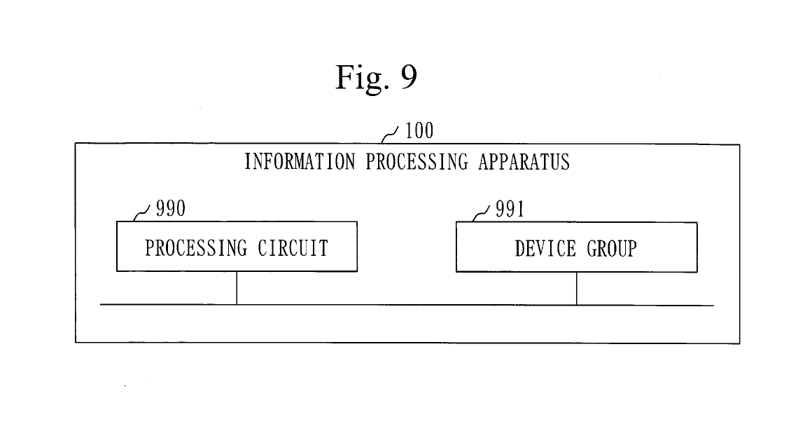

FIG. 9 illustrates a configuration for when the functions of the information processing apparatus 100 are implemented by hardware.

The information processing apparatus 100 includes a processing circuit 990 and a device group 991. The processing circuit 990 is also referred to as processing circuitry. The device group 991 is first devices 101 and second devices 102.

The processing circuit 990 is a dedicated electronic circuit that implements the initialization determining unit 201, the change determining unit 202, the assigning unit 203, the activating unit 204, the classifying unit 205, the updating unit 206, the restarting unit 207, the generating unit 208, and the storage unit.

For example, the processing circuit 990 is a single circuit, a combined circuit, a programmed processor, a parallel programmed processor, a logic IC, a GA, an ASIC, or an FPGA, or a combination thereof. GA is an abbreviation for Gate Array, ASIC is an abbreviation for Application Specific Integrated Circuit, and FPGA is an abbreviation for Field Programmable Gate Array.

The information processing apparatus 100 may include a plurality of processing circuits that substitute for the processing circuit 990. The plurality of processing circuits share the roles of the processing circuit 990.

The functions of the information processing apparatus 100 may be implemented by a combination of software and hardware. That is, some functions may be implemented by software and other functions may be implemented by hardware.

The embodiment is exemplification of a preferred mode and does not intend to limit the technical scope of the present invention. The embodiment may be partially implemented or may be implemented in combination with another embodiment. The procedures described using the flowcharts, etc., may be changed as appropriate.

### REFERENCE SIGNS LIST

100: information processing apparatus, 101: first device, 102: second device, 111: memory, 112: cache, 113: auxiliary storage apparatus, 120: processor, 121: first core, 122: second core, 130: hypervisor, 141: first operating system, 142: second operating system, 151: first device driver, 152: second device driver, 161: first application, 162: second application, 201: initialization determining unit, 202: change determining unit, 203: assigning unit, 204: activating unit, 205: classifying unit, 206: updating unit, 207: restarting unit, 208: generating unit, 211: first device configuration data, 212: second device configuration data, 221: first device configuration data, 222: second device configuration data, 990: processing circuit, 991: device group.

1-8. (canceled)

9. An information processing apparatus in which a first operating system and a second operating system run concurrently, wherein
a device group including a first device and a second device is connected to the information processing apparatus, the first device being assigned to the first operating system and the second device being assigned to the second operating system,
in the first operating system, a first device driver that supports the first device is installed, but a second device driver that supports the second device is not installed,
in the second operating system, the second device driver is installed, but the first device driver is not installed, and
the information processing apparatus comprises:
processing circuitry
to select a first device driver being a device driver installed in the first operating system, receive a result of device matching from the first device driver, classify a device that is notified as the result of device matching, in the device group, as a first device, and classify a device that is not classified as the first device, in the device group, as a second device;
to perform, after the device group is classified into the first device and the second device, an updating process for updating first device configuration data in which a device assigned to the first operating system is registered, to a state in which the first device is registered and the second device is not registered, and updating second device configuration data in which a device assigned to the second operating system is registered, to a state in which the second device is registered and the first device is not registered; and
to assign the first device to the first operating system with reference to the first device configuration data, and assign the second device to the second operating system with reference to the second device configuration data, after the updating process.

10. The information processing apparatus according to claim 9, wherein the processing circuitry
restarts the information processing apparatus after the updating process, and
after the information processing apparatus is restarted, assigns the first device to the first operating system with reference to the first device configuration data, and assigns the second device to the second operating system with reference to the second device configuration data.

11. The information processing apparatus according to claim 9, wherein the processing circuitry
determines, at start-up of the information processing apparatus, whether a device configuration of the information processing apparatus has been changed,
when the device configuration of the information processing apparatus has not been changed, assigns the first device to the first operating system with reference to current first device configuration data, and assigns the second device to the second operating system with reference to current second device configuration data, and
when the device configuration of the information processing apparatus has been changed, assigns the first device to the first operating system with reference to the first device configuration data obtained after the updating process, and assigns the second device to the second operating system with reference to the second device configuration data obtained after the updating process.

12. The information processing apparatus according to claim 1, wherein when an initialization instruction has been inputted at start-up of the information processing apparatus, the processing circuitry assigns the first device to the first operating system with reference to first device configuration data for initialization, and assigns the second device to the second operating system with reference to second device configuration data for initialization.

13. A device assignment method, wherein
a device group including a first device and a second device is connected to an information processing apparatus in which a first operating system and a second operating system run concurrently, the first device being assigned to the first operating system and the second device being assigned to the second operating system,
in the first operating system, a first device driver that supports the first device is installed, but a second device driver that supports the second device is not installed, and
in the second operating system, the second device driver is installed, but the first device driver is not installed,
the device assignment method comprising
selecting a first device driver being a device driver installed in the first operating system, receiving a result of device matching from the first device driver, classifying a device that is notified as the result of device matching, in the device group, as a first device, and classifying a device that is not classified as the first device, in the device group, as a second device;
performing, after the device group is classified into the first device and the second device, an updating process for updating first device configuration data in which a device assigned to the first operating system is registered, to a state in which the first device is registered and the second device is not registered, and updating second device configuration data in which a device assigned to the second operating system is registered, to a state in which the second device is registered and the first device is not registered, and
assigning the first device to the first operating system with reference to the first device configuration data, and assigning the second device to the second operating system with reference to the second device configuration data, after the updating process.

14. A non-transitory computer readable medium storing a device assignment program to be executed by a computer in which a first operating system and a second operating system run concurrently, wherein
a device group including a first device and a second device is connected to the computer, the first device being assigned to the first operating system and the second device being assigned to the second operating system,
in the first operating system, a first device driver that supports the first device is installed, but a second device driver that supports the second device is not installed,
in the second operating system, the second device driver is installed, but the first device driver is not installed, and
the device assignment program causes the computer to perform:
a classification process of selecting a first device driver being a device driver installed in the first operating system, receive a result of device matching from the first device driver, classify a device that is notified as the result of device matching, in the device group, as a first device, and classify a device that is not classified as the first device, in the device group, as a second device;
an updating process of updating first device configuration data in which a device assigned to the first operating system is registered, to a state in which the first device is registered and the second device is not registered, and updating second device configuration data in which a device assigned to the second operating system is registered, to a state in which the second device is registered and the first device is not registered, after the device group is classified into the first device and the second device; and
an assignment process of assigning the first device to the first operating system with reference to the first device configuration data, and assigning the second device to the second operating system with reference to the second device configuration data, after the updating process.
